(19) United States
(12) Patent Application Publication
(10) Pub. No.: US 2015/0012357 A1
(43) Pub. Date: Jan. 8, 2015

(54) METHOD AND SYSTEM FOR LOCATION SPECIFIC MARKETING CHANNELS

(71) Applicant: Sears Brands, L.L.C., Hoffman Estates, IL (US)

(72) Inventors: Sunilkumar Kakade, Gilberts, IL (US); Robert W. Pult, West Dundee, IL (US)

(73) Assignee: Sears Brands, L.L.C., Hoffman Estates, IL (US)

(21) Appl. No.: 13/936,838

(22) Filed: Jul. 8, 2013

(51) Int. Cl. G06Q 30/02

(52) U.S. Cl. CPC G06Q 30/0259
USPC 705/14.57

(57) ABSTRACT

A method and system are provided for enabling or supporting location specific marketing. In this regard, location specific marketing may comprise selecting a plurality of products for marketing in a particular location, and generating media output comprising promotional information relating to the plurality of products. The generated media output may be communicated to a plurality of interactive devices in the particular location, for outputting of the media output thereby. The particular location may comprise a retail store. The media output may sometimes be configured as a plurality of media sub-outputs, with each of the plurality of media sub-outputs corresponding to one of a plurality of sub-sections of the particular location.

### TECHNICAL FIELD

Aspects of the present application relate to user interactions. More specifically, certain implementations of the present disclosure relate to use of location specific marketing channels.

### BACKGROUND

Existing methods and systems, if any exist, for generating or using localized marketing channels can be costly, cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for location specific marketing channels, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example location that supports use of location specific marketing channels.

FIG. 2 illustrates an example system that may be used in managing location specific marketing channels.

FIG. 3 is a flow chart that illustrates an example process for generating and utilizing location specific marketing channels.

### DETAILED DESCRIPTION

Certain embodiments of the invention may be found in method and system for location specific marketing channels. As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

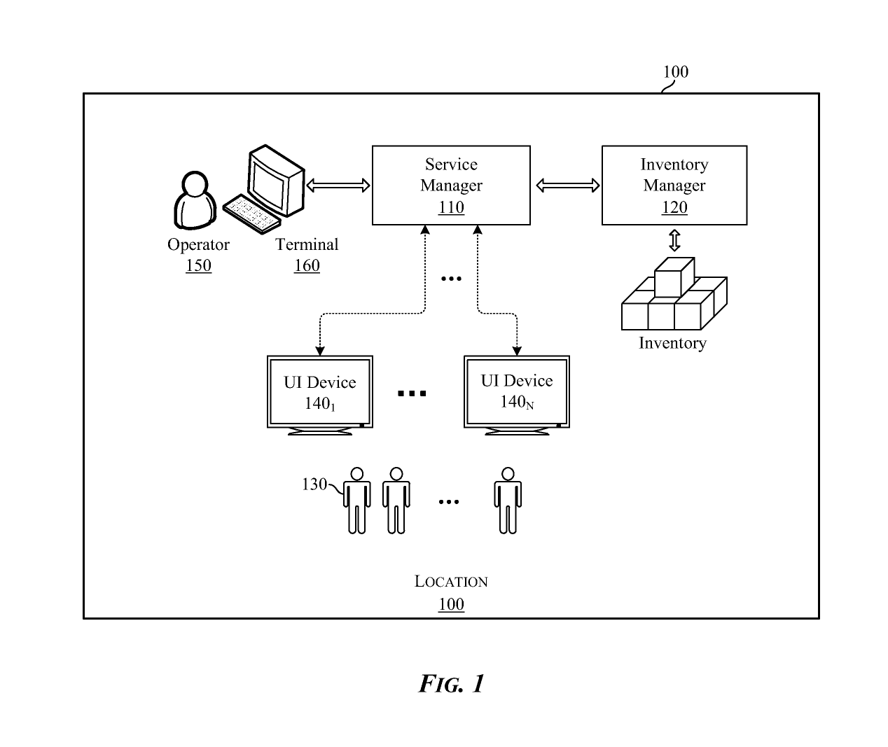

FIG. 1 illustrates an example location that supports use of location specific marketing channels. Referring to FIG. 1, there is shown a location 100. In this regard, the location 100 may correspond to, for example, a commercial location (e.g., a retail store). For example, the location 100 may be utilized to sell various types of goods or merchandise (e.g., appliances, clothing, toys, home supplies, etc.).

In some instances, various services may also be provided within the location 100. In this regard, the services provided in the location 100 may comprise services offered to consumers (e.g., paid WiFi access). In some instances, however, the services provided in the location 100 may be intended for and/or utilized by location operators (e.g., store/chain owning entities) or merchandise sellers. For example, in various implementations in accordance with the present disclosure, the location 100 may be configured to enable and/or support use of location specific marketing channels. In this regard, as shown in FIG. 1, the location 100 may comprise, for example, a service manager 110, an inventory manager 120, and a plurality of user interactive (UI) devices 140₁-140_{N}.

The service manager 110 may comprise suitable circuitry, interfaces, logic, and/or code for providing, supporting and/or managing various services or functions in a particular location (e.g., in the location 100). In this regard, the services provided by the service manager 110 may entail utilizing and/or interacting with a plurality of UI devices (e.g., the UI devices 140₁-140_{N}). The services or functions that may be provided and/or supported by the service manager 110 may pertain to, for example, providing location specific marketing channels.

The inventory manager 120 may comprise suitable circuitry, interfaces, logic, and/or code for managing inventory related data in the location 101. In this regard, the inventory managed via the inventory manager 120 may comprise goods, services or the like. For example, inventory manager 120 may generate, maintain, and/or update databases in storing inventory related information, such as information regarding remaining amount(s) of each item (e.g., particular product) offered in the location 101, per-item transaction related information (e.g., pricing, amount sold at each price point, etc.), consumption related information (e.g., timing of purchases, such as amounts sold per day, and/or per hour of each day), and the like.

Each user interactive (UI) device 140, may comprise suitable circuitry, interfaces, logic, and/or code for enabling interactions with users (e.g., users 130 in the location 100). For example, the UI devices 140₁-140_{N} comprise devices that may be configured for use in providing (e.g., displaying) particularly configured output to the users 130 in the location 100, and/or (in some instances) to receive input (or feedback) form the users 130. In this regard, in instances where the service manager 110 is utilized to support services relating to location specific marketing channels, the UI devices 140₁-140_{N} may be utilized as interactive devices in conjunction with these services (e.g., to display the marketing information, and/or to allow obtaining user input—e.g., request for additional information, or goods location data, etc.) Example of devices that may be utilized as UI devices 140₁-140_{N} may comprise televisions, monitors, Internet connected personal computers (PCs), interactive kiosks, and the like. The disclosure is not limited, however, to any particular type of devices.

In some instances, devices or systems in the location 100 (e.g., the UI devices 140₁-140_{N} and the service manager 110) may be operable to communicate with each other, such as to enable exchange of data (e.g., promotional information, operator preferences, user input/feedback, etc.). For example, the UI devices 140₁-140_{N} and the service manager 110 may be operable to communicate using, for example, one or more point-to-point links, over local network, or over the Internet. The disclosure is not limited, however, to particular mode of communication. In this regard, communications may be performed using wired, wireless, and/or optical links that may be suited for use in an environment such as the location 100. Examples of links/connections that may be supported and/or utilized in the location 100 may comprise wired connections (e.g., HDMI connections, DisplayPort links, Ethernet connections, or the like), and/or wireless connections (e.g., Wi-Fi, ZigBee, wireless USB, or the like).

In operation, the location 100 may be configured to enable or support use of location specific marketing channels (e.g., within the location 100). In this regard, with location specific marketing, promotional offers (e.g., offers of the day/time) may be generated, dynamically, and/or based on real-time data, such that these offers may be specific to the location, and more particularly to products that are available in the location. The use of location specific marketing may improve marketing effectiveness, by enhancing the ability to communicate store-product specific promotions (e.g., to the shopper community). The generated offers may be communicated by use of in-location marketing channels. In this regard, marketing channels may comprise use of video based marketing messaging, which may be outputted via available suitable devices, to communicate to the users (e.g., shoppers) the offers. In other words, when utilizing location specific marketing channels, existing (or new) video display devices may be utilized to display promotions that are particularly designed for the location, and/or in particular product areas thereof, thus allowing merchandise community to directly and effectively push offers.

For example, the location 100 may comprise a retail store, which may be used to offer or sell particular products (e.g., merchandise and/or services) to users (e.g., shoppers). Furthermore, in some instances the location 100 may be divided into plurality of sub-areas—e.g., when it comprise a retail store, the location 100 may be divided into a plurality of product areas, comprising, for example, clothing department, appliances department, tools department, automotive department, etc. In this regard, retail stores may be equipped in some instances with devices (e.g., devices 104₁-104_{N}, comprising interactive kiosks and/or internet connected PCs), which may typically be used to allow the users to browse for products (and in some instances products online or in store). Additionally, in instances where the retail store is divided into plurality of product areas, each product area may be assigned and/or served by one or more dedicated devices. Typically, when these devices are not being utilized by the users, they may become inactive (shut down, or sleep) or simply repeatedly provide generic output (e.g., show screen savers with generic information, such as the store name). Instead, when location specific marketing services are being implemented, these devices may be utilized to output (e.g., display) location specific marketing information (e.g., promotions specific to the location). Accordingly, when implementing location specific marketing services, existing infrastructure in locations (e.g., stores) may be utilized to allow creating and outputting marketing channels that may allow dynamically broadcasting offers that are not visible to shoppers.

In an example use scenario, as an initial step, data pertinent to the location specific marketing services may be determined and/or collected (including dynamically). The data may be used generate databases (or update databases, if previously created). For example, the database manager 120 may generate and/or update (e.g., dynamically) an inventory database relating to available inventory of products (for the location 100 as a whole, and/or for each product area). Meanwhile, the service manager 110 may generate and/or update (e.g., dynamically) device database, which may store information relating to detected and/or available devices. Furthermore, the service manager 110 may generate and/or update a location map—e.g., defining any product areas within the location 100. Accordingly, in some instances, the service manager 110 may map the detected/available devices to the product areas (e.g., matching IP address with product area identifiers). The service manager 110 may then generate location specific marketing offers, configured dynamically, such as based on current information (e.g., inventory, devices, store map, etc.). The location specific marketing offers may be configured as location specific channels. In this regard, the service manager 110 may utilize predefined video/audio (e.g., screensaver with audio description) template for delivery of video/audio promotion offer. The service manager 110 may then generate, for example, targeted offer for specific store for specific areas, suitable for display via corresponding one or more UI devices 104ᵢ in the product area(s). The generated video/audio promotional offer may then be communicated to the UI device(s) 104ᵢ. In some instances, rather than simply generating a single, location-all promotional offer, the service manager 110 may configure a plurality video/audio promotional offer, each particularly configured for each of different product areas and/or categories. The generation of the promotional offers may be done in different ways. For example, in some instances, a channel may be used to offer surprise deals, such as at various times, across the whole location or in particular areas. In other instances, the same channel may be used to broadcast hourly deals.

In an example implementation, an operator 150 may configure or control (e.g., via a PC terminal 160, configured for communication with the service manner 110) at least some aspects of the location specific marketing services provided in the location 100. For example, the operator 150 may define particular parameters, conditions, or criteria for use in location specific marketing services. The operator 150 may define, for example, inventory thresholds for triggering promotional offers (e.g., for the store as a whole, for one or more product categories, for one or more areas, etc.), timing conditions (e.g., hourly, at particular points such as those predetermined to correlate with high/low shopper flow, etc.), pricing parameters (e.g., maximum/minimum discounts/pricing allowed, for each product/product category, and whether or not these parameters are applied stand-alone in relation to other parameters—e.g., 20% for particular product, or scaled discounting ranging between 10% and 40% based exhaustion of inventory). The operator 150 may be local (i.e. within the location 100, utilizing a local terminal). Alternatively, however, the operator 150 may remote (i.e., external to the location 100, such as from chain headquarters, communicating with location 100 and devices therein using remote connections). In some instances, the location specific marketing services may be utilized (at plurality of locations) by remote operators. For example, merchandise sellers may be permitted to select particular location (e.g., store), section thereof (e.g., particular product area on the floor), and to dynamically generate and push localized offers (e.g., based on local inventory).

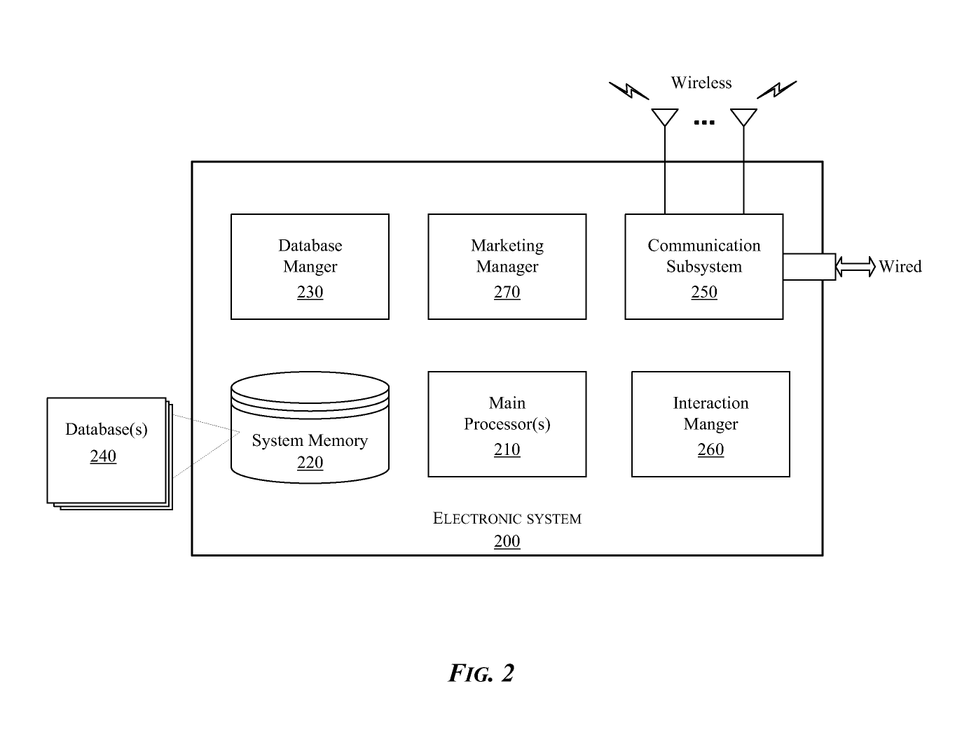

FIG. 2 illustrates an example system that may be used in managing location specific marketing channels. Referring to FIG. 2, there is shown an electronic system 200.

The electronic system 200 may comprise suitable circuitry, interfaces, logic, and/or code for implementing various aspects of the disclosure. In this regard, the electronic system 200 may be configured to support performing, executing or running various operations, functions, applications and/or services. For example, the electronic system 200 may be operable to support, managing services that may be supported and/or provided in a specific location. The electronic system 200 may be utilized as platform implementing the service manager 110 of FIG. 1. In this regard, services managed by the electronic device system 200 may comprise generation of location specific marketing for output, via suitable output terminals, to users (e.g., consumers) at particular location. In some instances, the electronic system 200 may be configured to enable and/or support communication of data, such as via wired and/or wireless connections, which may be configured in accordance with one or more supported wireless and/or wired protocols or standards. For example, the electronic system 200 may need to communicate with other systems during location specific marketing related operations, such as to obtain information needed for generating the location specific marketing content, and/or to communicate the content to various output terminals. In some instances, the electronic system 200 may be configured to enable or support input/output operations, such as to allow user interactions that may be needed for controlling services provided by the electronic system 200 (e.g., to allow operators to provide input or commands for controlling location specific marketing, or obtain output or feedback pertaining to it). In this regard, the electronic system 200 may comprise components or subsystems for enabling interactions with a user (e.g., end-user or installer), so as to obtain user input and/or to provide user output. Examples of electronic devices may comprise computers, servers, tablets, or the like. The disclosure, however, is not limited to any particular type of electronic device.

The electronic system 200 may comprise, for example, one or more main processors 210, a system memory 220, a database manager 230, a communication subsystem 250, an interaction manager 260, and a marketing manager 270.

The processor 210 may comprise suitable circuitry, interfaces, logic, and/or code that may be operable to perform general and/or specialized processing operations in the electronic device 210. For example, the processor 210 may comprise a general purpose processor (e.g., a central processing unit or CPU), a special purpose processor (e.g., graphics processing unit or GPU, or a visual processing unit or VPU), or the like. The disclosure, however, is not limited to any particular type of processor. When utilized as a general purpose processor, the processor 210 may be operable to, for example, process or handle data, control or manage operations of the electronic system 200, and/or handle or support tasks and/or applications performed therein. In this regard, the processor 210 may be utilized to configure and/or control operations of various components and/or subsystems of the electronic system 200, by utilizing, for example, one or more control signals. In some instances, however, the processor 210 may comprise a specialized processor, such as a video/graphics processor or a dedicated application processor that may be utilized for running and/or executing applications (or programs) in the electronic system 200.

The system memory 220 may comprise suitable circuitry, interfaces, logic, and/or code that may enable permanent and/or non-permanent storage, buffering, and/or fetching of data, code and/or other information, which may be used, consumed and/or processed. In this regard, the system memory 220 may comprise different memory technologies, including, for example, read-only memory (ROM), random access memory (RAM), Flash memory, solid-state drive (SSD), and/or field-programmable gate array (FPGA). The disclosure, however, is not limited to any particular type of memory or storage device. The system memory 220 may store, for example, configuration data, which may comprise parameters and/or code, comprising software and/or firmware. The disclosure is not limited, however, to any particular type of configuration data.

The database manager 230 may comprise suitable circuitry, interfaces, logic, and/or code in managing databases 240, which may be generated, accessed, and/or modified by the system 200. The databases 240 may be stored in dedicated partitions of the system memory 220 for example. In some instances, however, the databases 240 may be maintained external to the electronic system 200 (e.g., by separate, dedicated servers or other systems). The databases 240 may comprise, for example, inventory related database(s), device related database(s), location database(s), etc.

The communication subsystem 250 may comprise suitable circuitry, interfaces, logic, and/or code operable to communicate data from and/or to the electronic device, such as via one or more wired and/or wireless connections. The communication subsystem 250 may be configured to support one or more wired protocols and/or interfaces, and/or one or more wireless protocols and/or interfaces, facilitating transmission and/or reception of signals to and/or from the electronic system 200 and/or processing of transmitted or received signals in accordance with applicable wired or wireless protocols. Examples of wireless protocols or standards that may be supported and/or used by the communication subsystem 250 may comprise wireless personal area network (WPAN) protocols, such as Bluetooth (IEEE 802.15); near field communication (NFC) standards; wireless local area network (WLAN) protocols, such as WiFi (IEEE 802.11); cellular standards, such as 2G/2G+ (e.g., GSM/GPRS/EDGE, and IS-95 or cdmaOne) and/or 2G/2G+ (e.g., CDMA2000, UMTS, and HSPA); 4G standards, such as WiMAX (IEEE 802.16) and LTE; Ultra-Wideband (UWB), and/or the like. Examples of wired protocols and/or interfaces that may be supported and/or used by the communication subsystem 250 comprise Ethernet (IEEE 802.2), Fiber Distributed Data Interface (FDDI), Integrated Services Digital Network (ISDN), cable (DOCSIS) and Universal Serial Bus (USB) based interfaces. Examples of signal processing operations that may be performed by the communication subsystem 250 comprise, for example, filtering, amplification, analog-to-digital conversion and/or digital-to-analog conversion, up-conversion/down-conversion of baseband signals, encoding/decoding, encryption/decryption, and/or modulation/demodulation.

The interaction manager 260 may comprise suitable circuitry, interfaces, logic, and/or code enabling and/or managing interactions in the electronic system 200. In this regard, the interactions of the electronic system 200 may comprise interactions with other systems and/or with users (e.g., system installers or operators). For example, the interaction manager 260 may allow interactions operator configuring the electronic system 200 for use in providing location specific marketing, such as to allow obtaining input from, and/or to providing output to, the users (e.g., operators and/or shoppers). The interaction manager 260 may support use of various types of inputs and/or outputs, including, for example, video, audio, and/or text. In some instances, the interaction manager 260 may support use of dedicated I/O devices and/or components, which may be integrated within the electronic system 200 (not shown), or may be external to (and communicatively coupled with) the electronic system 200. In this regard, the dedicated I/O devices and/or components may be utilized for inputting and/or outputting data. Examples of dedicated I/O devices and/or components may comprise displays and similar video output components, audio I/O components (e.g., speakers and/or microphones), mice, keyboards, touch screens (or touchpads), and the like. In some instances, user input obtained via the interaction manager 260, may be used to configure and/or modify various functions of particular components or subsystems of the electronic system 200. For example, in instances where a user may be an ‘operator’ the user input may pertain to configuring various aspects of location specific marketing services, which may necessitate (or result) in affecting or modifying operations of such components as the marketing manager 270, the database manager 230, and the interaction manager 260 itself.

The marketing manager 270 may comprise suitable circuitry, interfaces, logic, and/or code for managing marketing operations. For example, the marketing manager 270 may be configured to enable or support location specific marketing, as described with respect to FIG. 1 for example.

In operation, the electronic system 200 may be utilized in supporting or enabling location specific marketing services, at a particular location (e.g., the location 100), as described with respect to FIG. 1 for example. In this regard, the electronic system 200 may correspond to one or more of the elements described in FIG. 1, such as the marketing manager 270 (and, in some instances, at least a portion of the inventory manager 230 and/or the operator terminal 160). For example, in an example use scenario, the electronic system 200 may be configured to monitor for and/or collect (or obtain) data that may pertinent to location specific marketing services, and to do so (at least in some instance) in dynamic and/or real-time manner. The electronic system 200 may then process the collected/obtained data. In this regard, processing the data may comprise generate (or updating databases, if already generated) various databases. For example, the database manager 230 may generate and/or update (e.g., dynamically) one or more of inventory database, device database (e.g., comprising information relating to devices with which the electronic system 200 may interact), and/or a location database (e.g., storing location map related information, which may comprise physical description of the a particular location, including any particular sub-sections thereof, such as product areas of a store). The marketing manager 270 may then generate location specific marketing offers, configured dynamically, such as based on current information (e.g., inventory, devices, location map, etc.). The location specific marketing offers may be configured as location specific channels. For example, the marketing manager 270 may generate media (video/audio) based promotional offers (e.g., screensaver with audio description), which may be specifically configured and/or formatted for output via particular output devices (e.g., Internet connected PCs or kiosks). Furthermore, in some instances, the generated marketing output may be configured such that it (or portions thereof) may be targeted offer for specific areas of the location, and/or specific products (or categories thereof). The electronic system 200 may the communicated the generated promotional offer(s), such as via the communication subsystem 250, to the output device(s).

In some instances, the electronic system 200 may support interactions (e.g., with operators) for allowing controlling and/or configuring of the location specific marketing operations. For example, a system operator (service administrator—e.g., store owner or merchandise provider) may define marketing control information, which may comprise parameters, conditions, or criteria for use in controlling or adjusting location specific marketing services, as described with respect to FIG. 1 for example. The operator may then provide the marketing control information to the electronic system 200 (using user interactions, as facilitated by the interaction manager 240, and/or communicated via connections supported by the communication subsystem 250), and the electronic system 200 may utilized that information (e.g., via the marketing manager 270) to setup, configure, and/or adjust location specific marketing operations.

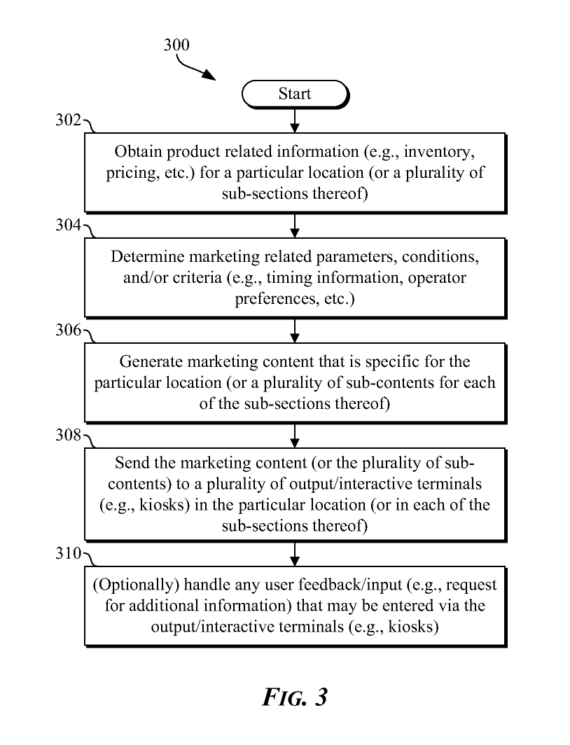

FIG. 3 is a flow chart that illustrates an example process for generating and utilizing location specific marketing channels. Referring to FIG. 3, there is shown a flow chart 300 comprising a plurality of example steps. The process depicted in flow chart 300 may be performed by a particular system (e.g., the electronic system 200), at a particular location (e.g., the location 101).

In step 302, product related information (e.g., inventory, pricing, etc.) for a particular location, such as a store may be obtained. In this regard, in some instances, the product related information may be sufficiently detailed as to apply to plurality of sub-sections of the location. For example, where the particular location comprises a store, the sub-sections may correspond to particular sections of the store (e.g., toy section, children section, women's clothing, etc.), and as such the product information may be applicable to each of the (sub-)sections. In step 304, marketing related parameters, conditions, and/or criteria may be determined. In this regard, marketing related parameters, conditions, and/or criteria may comprise, for example, timing information, operator preferences, or the like. For example, operator(s) may specify that marketing content should be generated at particular time (e.g., 5:00 pm), when the amount of inventory for particular product reaches particular value, and that marketing comprises offering of particular price discount or purchase incentive (buy two, get one free). In step 306, location specific marketing content specific for the particular location may be generated. In this regard, the location specific marketing content may be configured particularly for outputting via particular type of devices (e.g., interaction kiosk) in particular manner. In some instances, the location specific marketing content may comprise a plurality of sub-contents (e.g., each corresponding to one of the sub-sections thereof). In step 308, the location specific marketing content (or the plurality of sub-contents) may be communicated to a plurality of output/interactive terminals (e.g., kiosks, or computer terminals) that may be in the particular location (or in each of the sub-sections thereof). In step 310, any user feedback/input (e.g., request for additional information), which may be entered via the output/interactive terminals (e.g., kiosks), may be optionally handled. In this regard, the handling may comprise searching for or obtaining (e.g., by prompting operator(s)) requesting information, and communicating that information to the output/interactive terminals for outputting back to the user thereby.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for location specific marketing channels.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method, comprising:
selecting a plurality of products for marketing in a particular location;
generating media output comprising promotional information relating to the plurality of products; and
outputting the generated media output via a plurality of interactive devices in the particular location.

2. The method of claim 1, wherein the particular location comprises a store.

3. The method of claim 1, wherein plurality of interactive devices comprise one or more interactive kiosks, computer terminals, display terminals, and/or televisions.

4. The method of claim 1, comprising selecting the plurality of products adaptively based on one or more of: time, spatial information, product inventory data, and/or marketing preferences.

5. The method of claim 4, wherein spatial information comprises information defining a plurality of sub-sections of the particular location.

6. The method of claim 1, wherein the media output comprises a plurality of media sub-outputs, with each of the plurality of media sub-outputs corresponding to one of a plurality of sub-sections of the particular location.

7. The method of claim 6, comprising outputting each of the plurality of media sub-outputs via one or more of the plurality of interactive devices that are located in the corresponding one of the plurality of sub-sections of the particular location.

8. The method of claim 6, comprising configuring each of the plurality of media sub-outputs based on determination of available products in the corresponding one of the plurality of sub-sections of the particular location.

9. The method of claim 1, comprising handling user input entered via one or more of the plurality of interactive devices.

10. The method of claim 1, wherein the user input comprises request for additional information regarding marketed products, and the handling comprises providing, via at least one of the plurality of interactive devices a respond to the request for the additional information.

11. A system, comprising:
one or more circuits for use in an electronic device, the one or more circuits being operable to:
select a plurality of products for marketing in a particular location;
generate media output comprising promotional information relating to the plurality of products; and
communicate the generated media output to a plurality of interactive devices in the particular location, for outputting of the media output thereby.

12. The system of claim 11, wherein the particular location comprises a store.

13. The system of claim 11, wherein plurality of interactive devices comprise one or more interactive kiosks, computer terminals, display terminals, and/or televisions.

14. The system of claim 11, wherein the one or more circuits are operable to select the plurality of products adaptively based on one or more of: time, spatial information, product inventory data, and/or marketing preferences.

15. The system of claim 14, wherein spatial information comprises information defining a plurality of sub-sections of the particular location.

16. The system of claim 11, wherein the one or more circuits are operable to generate the media output as a plurality of media sub-outputs, with each of the plurality of media sub-outputs corresponding to one of a plurality of sub-sections of the particular location.

17. The system of claim 16, wherein each of the plurality of media sub-outputs is outputted via one or more of the plurality of interactive devices that are located in the corresponding one of the plurality of sub-sections of the particular location.

18. The system of claim 16, wherein the one or more circuits are operable to generate each of the plurality of media sub-outputs based on determination of available products in the corresponding one of the plurality of sub-sections of the particular location.

19. The system of claim 11, wherein the one or more circuits are operable to handle user input entered via one or more of the plurality of interactive devices.

20. The system of claim 11, wherein the user input comprises request for additional information regarding marketed products, and the handling comprises providing, via at least one of the plurality of interactive devices a respond to the request for the additional information.
